(19) United States
(12) Patent Application Publication
(10) Pub. No.: US 2024/0413955 A1
(43) Pub. Date: Dec. 12, 2024

(54) FORM FACTOR OR FEATURE CONDITIONS FOR 2RX-100 MHZ WIRELESS COMMUNICATION

(71) Applicant: QUALCOMM Incorporated, San Diego, CA (US)

(72) Inventors: Mohamed Atef Abdelazim SHEHATA, Lannion (FR); Prashanth Haridas HANDE, San Diego, CA (US); Chih-Ping LI, San Diego, CA (US); Mickael MONDET, Louannec (FR); Peerapol TINNAKORNSRISUPHAP, San Diego, CA (US); Allen Minh-Triet TRAN, Rancho Santa Fe, CA (US); Peter GAAL, San Diego, CA (US)

(21) Appl. No.: 18/617,519

(22) Filed: Mar. 26, 2024

Related U.S. Application Data
(60) Provisional application No. 63/507,426, filed on Jun. 9, 2023.

(51) Int. Cl. H04L 5/00; H04W 72/0453

(52) U.S. Cl. CPC H04L 5/0064; H04L 5/0048; H04W 72/0453

(57) ABSTRACT

A method for wireless communication at a user equipment (UE) and related apparatus are provided. In the method, the UE receives an allocation of resources on a communication bandwidth of 100 MHz for communication with a network entity; and communicates, using two receive antennas and the communication bandwidth, with the network entity, based on meeting a condition comprising at least one of a form factor condition of an apparatus comprising the UE or a feature condition for the communication with the network entity.

### CROSS REFERENCE TO RELATED APPLICATION(S)

This application claims the benefit of and priority to U.S. Provisional Application Ser. No. 63/507,426, entitled “FORM FACTOR OR FEATURE CONDITIONS FOR 2RX-100 MHz WIRELESS COMMUNICATION” and filed on Jun. 9, 2023, which is expressly incorporated by reference herein in its entirety.

### TECHNICAL FIELD

The present disclosure relates generally to communication systems and, more particularly, to wireless communication using two receive antennas utilizing the communication bandwidth of 100 MHz (2RX-100 MHz).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to receive an allocation of resources on a communication bandwidth of 100 MHz for communication with a network entity; and communicate, using two receive antennas and the communication bandwidth, with the network entity, based on meeting a condition including at least one of a form factor condition of the apparatus or a feature condition for the communication with the network entity.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to receive, from a UE, an indication of an apparatus type or a capability for using two receive antennas and a communication bandwidth of 100 MHz; allocate resources for the UE based on the communication bandwidth of 100 MHz; and communicate with the UE using the allocated resources on the communication bandwidth.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating examples of surface areas and sizes of a device in accordance with various aspects of the present disclosure.

FIG. 5 is a diagram illustrating example aspects of extended reality (XR) wireless traffic.

FIG. 6A is a call flow diagram illustrating the signaling of the UE form factor condition or UE feature information in accordance with various aspects of this present disclosure.

FIG. 6B is a call flow diagram illustrating the signaling of the UE form factor condition or UE feature information in accordance with various aspects of this present disclosure.

FIG. 7 is a call flow diagram illustrating a method of wireless communication in accordance with various aspects of the present disclosure.

FIG. 8 is a flowchart illustrating methods of wireless communication at a UE in accordance with various aspects of the present disclosure.

FIG. 9 is a flowchart illustrating methods of wireless communication at a UE in accordance with various aspects of the present disclosure.

FIG. 10 is a flowchart illustrating methods of wireless communication at a network entity in accordance with various aspects of the present disclosure.

FIG. 11 is a flowchart illustrating methods of wireless communication at a network entity in accordance with various aspects of the present disclosure.

FIG. 12 is a diagram illustrating an example of a hardware implementation for an example apparatus and/or network entity.

FIG. 13 is a diagram illustrating an example of a hardware implementation for an example network entity.

### DETAILED DESCRIPTION

Wireless communication with 100 MHz bandwidth may use four receive antennas (4RX). However, such a 4RX configuration involves added hardware components for devices like Augmented Reality (AR) glasses, particularly at low frequency bands. On the other hand, devices with two receive antennas (2RX) may be limited to communication with a bandwidth (BW) of 20 MHz. Aspects presented herein provide form factor conditions and/or communication feature conditions that may be used in connection with 2RX wireless communication over a 100 MHz bandwidth, which may provide data rate and latency requirements for wireless traffic, such as XR traffic, while allowing for reduced hardware in devices meeting the conditions. Example aspects presented herein provide a 2RX configuration with a bandwidth of 100 MHz for a user equipment (UE) in wireless communication.

Various aspects relate generally to communication systems. Some aspects more specifically relate to methods and apparatus related to one or more form factor conditions for devices with two receive antennas to utilize a 100 MHz communication bandwidth (2RX-100 MHz device). In some aspects, form factor conditions for the device to use 2RX-100 MHz communication may include an antenna placement volume/area/size threshold, a length, breadth and/or width threshold of the device, a TDP limit, and/or a battery size of the device. In some aspects, feature conditions of wireless communication for 2RX 100 MHz communication may include an absence of carrier aggregation, the maximum rank threshold, and/or a threshold number of supported quality of service (QOS) flows. In some examples, a UE may receive an allocation of resources on a communication bandwidth of 100 MHz for communication with a network entity. The UE may then communicate, using two receive antennas and the communication bandwidth, with the network entity, based on meeting a condition including at least one of a form factor condition of an apparatus including the UE or a feature condition for the communication with the network entity.

Particular aspects of the subject matter described in this disclosure can be implemented to realize one or more of the following potential advantages. The aspects presented herein enable conditions for the use of 2RX-100 MHz communication, which may enable some devices to balance hardware complexity and QoS, while maintaining some control over the use of 2RX-100 MHz communication. The aspects presented herein enable a 2RX device with 100 MHz bandwidth with reduced hardware, while still meeting the QoS conditions for extended reality (XR) traffic. In some examples, by outlining the form factor conditions related to such hardware constraints, the described techniques can be used to make the devices more suitable for applications that have size and/or power conditions. In some examples, by limiting Carrier Aggregation, the maximum rank, and the number of QoS flows, the described techniques can be used to ensure that the unique functionality of these devices is used appropriately, maintaining network integrity and efficiency.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

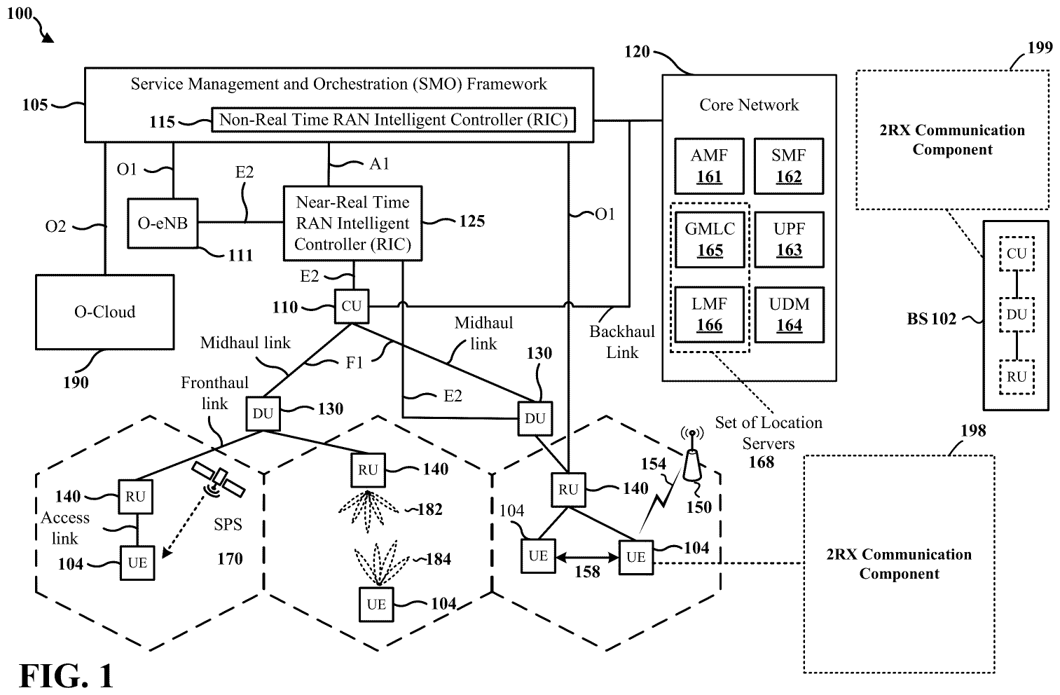

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a 2RX communication component 198. The 2RX communication component 198 may be configured to receive an allocation of resources on a communication bandwidth of 100 MHz for communication with a network entity; and communicate, using two receive antennas and the communication bandwidth, with the network entity, based on meeting a condition including at least one of a form factor condition of the apparatus or a feature condition for the communication with the network entity. In certain aspects, the base station 102 may include a 2RX communication component 199. The 2RX communication component 199 may be configured to receive, from a UE, an indication of an apparatus type or a capability for using two receive antennas and a communication bandwidth of 100 MHz; allocate resources for the UE based on the communication bandwidth of 100 MHz; and communicate with the UE using the allocated resources on the communication bandwidth. Although the following description may be focused on 5G NR, the concepts described herein may be applicable to other similar areas, such as LTE, LTE-A, CDMA, GSM, and other wireless technologies.

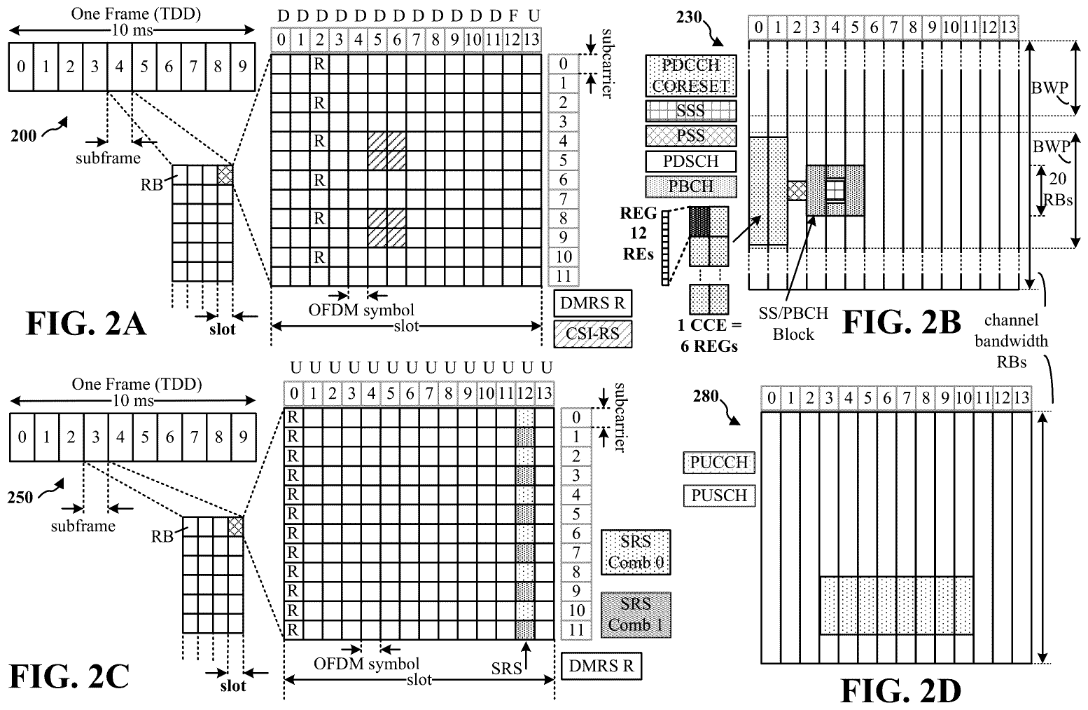

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

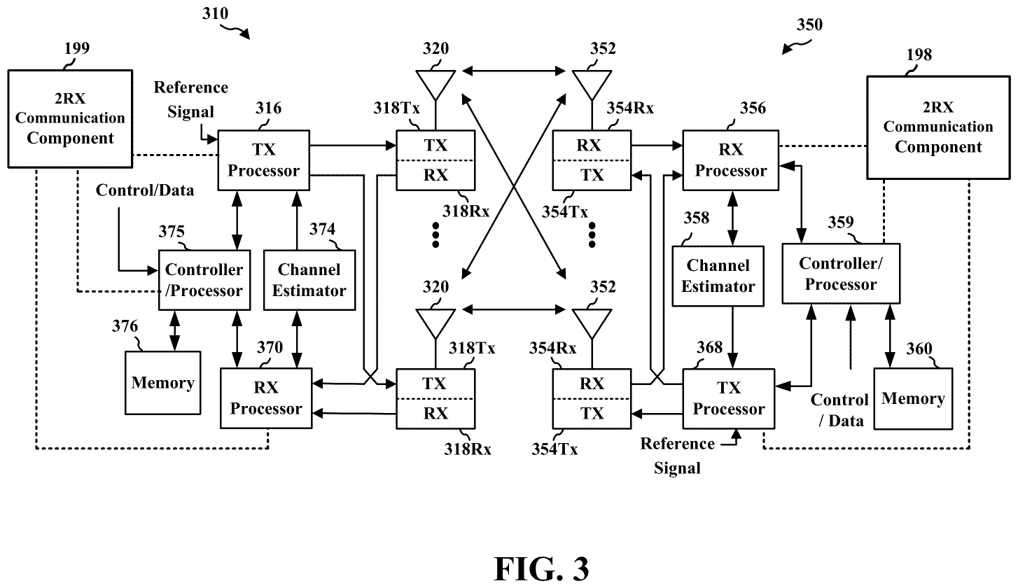

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the 2RX communication component 198 of FIG. 1.

At least one of the TX processor 316, the RX processor 370, and the controller/processor 375 may be configured to perform aspects in connection with the 2RX communication component 199 of FIG. 1.

A wireless communication system, such as described in connection with FIG. 1, may support various types of wireless traffic. One type of wireless traffic that may be supported includes XR traffic, which may include high data rates and low latency. XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

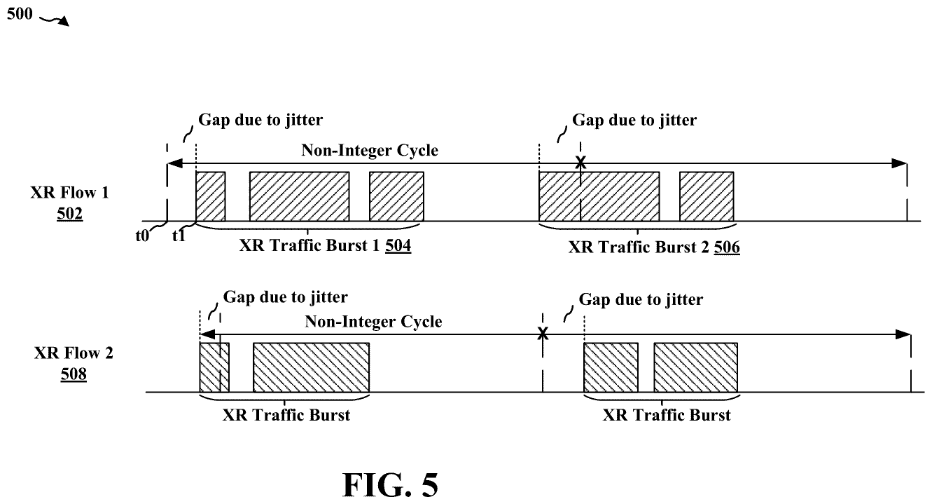

XR traffic may arrive in periodic traffic bursts (“XR traffic bursts”). An XR traffic burst may vary in a number of packets per burst and/or a size of each pack in the burst. FIG. 5 illustrates an example diagram 500 showing a first XR flow 502 that includes a first XR traffic burst 504 and a second XR traffic burst 506. As illustrated in the diagram 500, the traffic bursts may include different numbers of packets, e.g., the first XR traffic burst 504 being shown with three packets (represented as rectangles in the diagram 500) and the second XR traffic burst 506 being shown with two packets. Furthermore, as illustrated in the diagram 500, the three packets in the first XR traffic burst 504 and the two packets in the second XR traffic burst 506 may vary in size, that is, packets within the first XR traffic burst 504 and the second XR traffic burst 506 may include varying amounts of data.

XR traffic bursts may arrive at non-integer periods (i.e., in a non-integer cycle). The periods may be different than an integer number of symbols, slots, etc. In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from −4 ms (earlier than expected arrival) to +4 ms (later than expected arrival). For instance, referring to the first XR flow 502, a UE may expect a first packet of the first XR traffic burst 504 to arrive at time t0, but the first packet of the first XR traffic burst 504 arrives at time t1.

XR traffic may include multiple flows that arrive at a UE (or a base station) concurrently with one another (or within a threshold period of time). For instance, the diagram 500 includes a second XR flow 508. The second XR flow 508 may have different characteristics than the first XR flow 502. For instance, the second XR flow 508 may have XR traffic bursts with different numbers of packets, different sizes of packets, etc. In an example, the first XR flow 502 may include video data and the second XR flow 508 may include audio data for the video data. In another example, the first XR flow 502 may include intra-coded picture frames (I-frames) that include complete images and the second XR flow 508 may include predicted picture frames (P-frames) that include changes from a previous image.

As noted herein, XR traffic may have an associated e2e PDB. If a packet does not arrive within the e2e PDB, a UE (or a base station) may discard the packet. In an example, if a packet corresponding to a video frame of a video does not arrive at a UE within an e2e PDB, the UE may discard the packet, as the video has advanced beyond the frame. However, the PDB at the UE may be unaccounted for in consideration of discarding packets. In general, XR traffic may be characterized by relatively high data rates and low latency. The latency in XR traffic may affect the user experience. For instance, XR traffic may have applications in eMBB and URLLC services.

XR traffic may be based on the use of four receive antennas (4RX) with a communication bandwidth of 100 MHz. However, due to hardware limitations, 4RX may not be possible on many AR devices, such as AR glasses, particularly at low frequency bands. For example, such devices may include 2 RX antennas rather than 4 RX antennas. However, communication with devices having two receive antennas (2RX devices) may be limited to a bandwidth (BW) of 20 MHz, which may not enable the device to meet the data rate and latency requirements of XR traffic. Table 2 shows example wireless communication operating bands with a 4RX condition (e.g., requirement) for 100 MHz communication. In Table 2, NR bands n7, n38, and n41 are bands for which 2RX would be helpful for AR devices (e.g., AR glass) (e.g., 2RX for 100 MHz), and NR bands n48 to n104 may be bands where four receive antennas (4RX) may be retained for AR devices (e.g., AR glass).

TABLE 2
5G operating bands with the 4RX requirement

| NR bands | Uplink | Downlink | Duplex |
|---|---|---|---|
| n7 | 2500 MHz-2570 MHz | 2620 MHz-2690 MHz | FDD |
| n38 | 2500 MHz-2570 MHz | 2620 MHz-2690 MHz | FDD |
| n41 | 2496 MHz-2690 MHz | 2496 MHz-2690 MHz | TDD |
| n48 | 3550 MHz-3700 MHz | 3550 MHz-3700 MHz | TDD |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n104 | 6425 MHz-7125 MHz | 6425 MHz-7125 MHz | TDD |

Example aspects presented herein provide approaches to enhance the functionality and practicality of 2RX-100 MHz devices while maintaining control of 2RX-100 MHz communication. Aspects presented herein provide one or more conditions based on the form factor of a device and/or features of wireless communication in order to use the 2RX-100 MHz devices and help to avoid misuse of the 2RX-100 MHz communication.

In some aspects, form factor conditions for the device can help to ensure the suitability of 2RX-100 MHz devices for various use cases, including vehicular use cases or AR glasses, among other examples.

In some aspects, one or more form factor conditions may include at least one physical characteristic condition of the device. The physical characteristic condition(s) of the device may include the volume, surface area, or size of the device. Further, the condition may further extend to the antenna placement portion of the device (e.g., the portion of the device dedicated to antenna placement). For example, the form factor condition may include the conditions on the physical characteristics of the antenna placement portion of the device, such as volume, surface area, or size of the antenna placement portion of the device. The condition(s) may be different for different frequencies of wireless communication, in some aspects.

In some examples, the form factor condition may be based on the volume of the device. For example, the form factor condition may indicate that a device is expected to have the maximum volume of X_{vd} for lower band (LB) frequencies, Y_{vd} for mid band frequencies, and/or Z_{vd} for high band (HB) frequencies in order to use 2RX-100 MHz communication. The condition may be based on the antenna placement portion of the device. For example, the form factor condition may specify that the volume of the antenna placement portion of the device may not exceed the volume Xᵥₐ for LB frequencies, Yᵥₐ for mid band frequencies, and/or Zᵥₐ for HB frequencies in order to use 2RX-100 MHz communication.

In some examples, the form factor condition may be based on the surface area of the device. For example, the form factor condition may specify that the surface of the device is not to exceed X_{sd} for LB frequencies, Y_{sd} for mid band frequencies, and/or Z_{sd} for HB frequencies in order to use 2RX-100 MHz communication. Similar to the condition for the volume of the device, the condition for the surface area may be based on a surface area of the antenna placement portion of the device. For example, the form factor condition may specify that the surface area of the antenna placement portion of the device may not exceed Xₛₐ for LB frequencies, Yₛₐ for mid band frequencies, and Zₛₐ for HB frequencies in order to use 2RX-100 MHz communication.

In some examples, the form factor condition may be based on the size of the device, which may be the summation of length, breadth, and height of the device. For example, the form factor condition may specify that the size of the device may not exceed X_{szd} for LB frequencies, Y_{szd} for mid band frequencies, and Z_{szd} for HB frequencies in order to use 2RX-100 MHz communication. This size condition may be based on the size of the antenna placement portion of the device. For example, the form factor limitation may specify that the size of the antenna placement portion of the device may not exceed X_{sza} for LB frequencies, Y_{sza} for mid band frequencies, and Z_{sza} for HB frequencies in order to use 2RX-100 MHz communication.

In some examples, the condition for the size of the device or the antenna placement portion of the device may be based on one or more of the length, breadth, or height of the device or the antenna placement portion of the device individually. For example, the form factor condition may specify that the length of the device (or the antenna placement portion of the device) is less than the maximum length Lₘₐₓ, the breadth of the device (or the antenna placement portion of the device) is to be less than the maximum breadth Bₘₐₓ, and/or the height of the device (or the antenna placement portion of the device) is to be less than the maximum height Hₘₐₓ in order to use 2RX-100 MHz communication.

In some examples, the form factor condition may be based on the thermal dissipation and power (TDP) of the device. For example, the form factor condition may specify that the device is to have a TDP limit of no more than T milliwatts in order to use 2RX-100 MHz communication.

In some examples, the form factor condition may be based on the battery size of the device. For example, the form factor condition may specify that the device's battery size is not to exceed B milliampere-hours (mAh) in order to use 2RX-100 MHz communication.

The specific values of the condition(s) for volume, surface area, and/or size for the device or the antenna placement portion of the device, the TDP limit, and the battery size limit (e.g., the values of X_{vd}, Y_{vd}, Z_{vd}, Xᵥₐ, Yᵥₐ, Zᵥₐ, X_{sd}, Y_{sd}, Z_{sd}, Xₛₐ, Yₛₐ, Zₛₐ, X_{szd}, Y_{szd}, Z_{szd}, X_{sza}, Y_{sza}, Z_{sza}, Lₘₐₓ, Bₘₐₓ, Hₘₐₓ, T, and B) may be defined (e.g., known to the device and/or the network in advance of communication). For example, one or more of the thresholds may be defined in a wireless standard. In some aspects, one or more thresholds may be configured for the UE and provided to the UE by a network.

In some examples, the volume, surface area, or size of a device (or the antenna placement portion of the device) may not be associated with the ruggedization of the device, and the segment may allow the placement of electronic components without hindrance.

Additionally, the volume, surface area, or size of a device (or the antenna placement portion of the device) may not be conducive to the placement of antennas due to mechanical issues, such as difficulties in routing cables to the baseband. For example, for an AR eye glass, the volume, surface area or size of the antenna placement portion of the glass may be a subset of the volume, surface area, or size of the glass. The volume, surface area, or size of the portion of the eye glass where routing cables is impractical or detrimental to device function may be excluded.

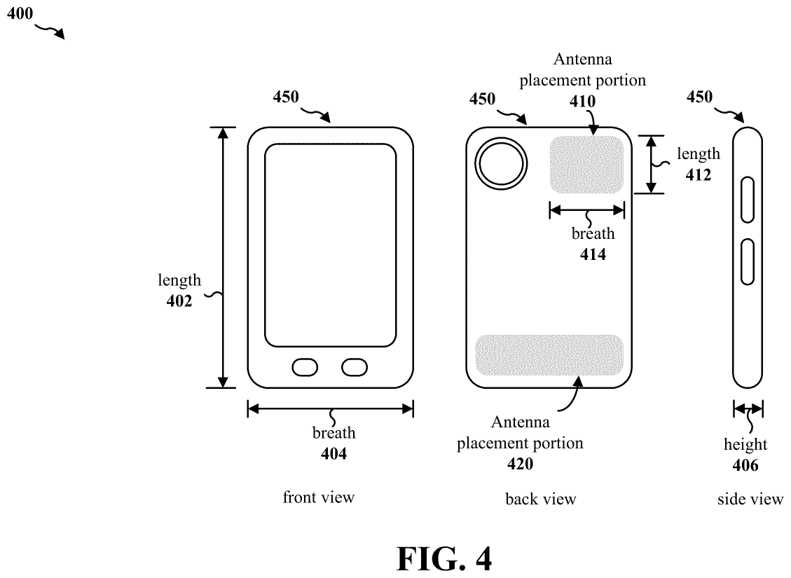

FIG. 4 is a diagram 400 illustrating examples of surface areas and sizes of a device in accordance with various aspects of the present disclosure. In FIG. 4, a smartphone is used as an example device. However, this example is not intended to be limiting, and the aspects presented herein can be applied to other devices, such as an AR glass or vehicular user equipment (VUE), among other examples of devices. As described above, the device may support XR traffic. Examples of such devices may include VR devices (such as a VR headset), MR devices, AR devices, among other examples. As shown in FIG. 4, the length, breadth, and height of the device may be length 402, breadth 404, and height 406, respectively. The size of the device may be the summation of the length 402, breadth 404, and height 406. The volume of the device may be the multiplication of length 402, breadth 404, and height 406, and the surface area of the device may be the multiplication of length 402 and breadth 404. The antenna placement portion of the device may include the portion of the device where the antennas are placed, which may be, for example, the antenna placement portion 410 and the antenna placement portion 420. For the antenna placement portion 410, the surface area may be the multiplication of length 412 and breadth 414.

Example aspects presented herein provide feature conditions for 2RX-100 MHz wireless communication. The feature condition may be designed to curb the potential misuse of 2RX-100 MHz communication.

In some examples, the feature conditions may include an absence of carrier aggregation (e.g., that carrier aggregation be disabled or not enabled) in order to use 2RX-100 MHz communication. Carrier aggregation is a feature that combines multiple carrier frequencies to increase data rates. Carrier aggregation may be restricted to help provide fair use of bandwidth and avoid misuse that might result from the aggregation of multiple channels.

In some examples, the feature condition may be based on the maximum rank in order to use 2RX-100 MHz communication. The maximum rank may refer to the maximum number of data streams that can be transmitted simultaneously from the device. For example, the feature condition for use 2RX-100 MHz communication may specify that the maximum rank is 2 for a 2RX device, rather than the maximum rank of 4 for a 4RX device.

In some examples, the feature condition may be based on the maximum number of supported QoS flows in order to use 2RX-100 MHz communication. For example, the feature limitation may specify that the number of QoS flows is not to exceed X, with X being less than or equal to 32, in order to use 2RX-100 MHz communication.

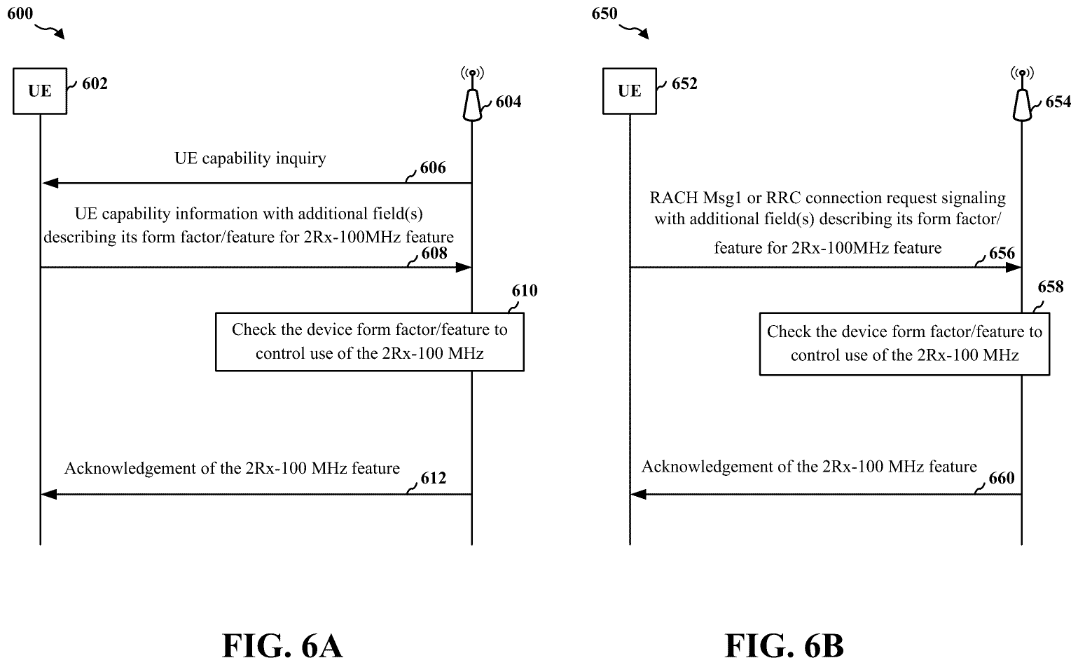

FIG. 6A is a call flow diagram 600 illustrating the signaling of the UE form factor condition or UE feature condition in accordance with various aspects of the present disclosure. Various aspects are described in connection with a UE 602 and a base station 604. The aspects may be performed by the UE 602 or may be performed by the base station (e.g., 102, 310) in aggregation and/or by one or more components of the base station 604 (e.g., a CU 110, a DU 130, and/or an RU 140). In some aspects, the UE 602 may correspond to the UE 104, 350, 702; the device 450; or the apparatus 1204. In some aspects, the UE may support XR traffic, e.g., as described in connection with FIG. 5. In some aspects, the UE may be a VUE, a VR devices (such as a VR headset), MR devices, or AR devices (such as an AR glass), among other examples.

In FIG. 6A, at 606, the base station 604 may send (e.g., transmit) a UE capability inquiry to the UE 602.

At 608, the UE 602 may send (e.g., transmit) the UE capability information to the base station 604, e.g., in response to the UE capability inquiry. The UE capability information may be sent with one or more field(s) describing a form factor and/or feature capability that is associated with a 2RX-100 MHz feature.

The UE capability signaling (e.g., the inquiry and/or information) may be transmitted via RRC signaling (e.g., an RRC message), and may be based on, or include, signaling mechanisms with one or more added additional field(s) regarding the form factor or the feature that identifies the UE 602 as a candidate device for 2RX-100 MHz features. In some aspects, the field(s) may indicate a type of the UE and/or one or more form factors regarding the UE. In some aspects, the field(s) may indicate that the UE meets one or more conditions for 2RX-100 MHz communication. In some aspects, the field(s) may indicate a feature condition that is met to enable 2RX-100 MHz wireless communication.

At 610, the base station 604 may check the device form factor information, feature information, or UE type information to avoid the misuse of the communication with 2RX and 100 MHz communication bandwidth. For example, the base station 604 may check whether the UE 602 meets the form factor condition or feature condition for 2RX-100 MHz communication based on the form factor and features UE 602 provided.

If the base station 604 identifies that the UE 602 meets one or more form factor conditions and/or feature conditions for 2RX-100 MHz communication, the base station 604 may, at 612, transmit to the UE 602 an acknowledgment acknowledging the 2RX-100 MHz feature. As used herein, the “2RX-100 MHz communication” may refer to the communication in which the UE uses two receive antennas and the communication bandwidth is approximately 100 MHz. The “2RX-100 MHz feature” may refer to the UE's capability or eligibility to use the “2RX-100 MHz communication.” If the base station determines that the UE does not meet the condition(s), the base station may skip sending the acknowledgement.

FIG. 6B is a call flow diagram 650 illustrating the signaling of the UE form factor information or UE feature information in accordance with various aspects of this present disclosure. Various aspects are described in connection with a UE 652 and a base station 654. The aspects may be performed by the UE 652 or the base station 654 in aggregation and/or by one or more components of the base station 654 (e.g., such as a CU 110, a DU 130, and/or an RU 140).

In FIG. 6B, at 656, the UE 652 may send to the base station 654 random access channel (RACH) Msg1 (e.g., which may be referred to as a first random access message) or RRC connection request signaling with additional field(s) describing the form factor of the UE or a feature associated with 2RX-100 MHz communication. In some aspects, the indication of the form factor or feature associated with the 2RX-100 MHz communication may be referred to as capability signaling.

In the example of FIG. 6B, the UE may transmit the UE capability signaling (e.g., capability information signaled to the base station) using (e.g., reusing) RACH Msg 1 signaling or RRC connection request signaling, with one or more additional field(s) on information regarding the form factor or the feature that identifies the UE 652 as a candidate device for the 2RX-100 MHz feature. For example, a first type of RACH Msg1 or RRC connection request may not include a field(s) for information about a form factor or a feature associated with the 2RX-100 MHz feature, and the UE may transmit a second type of RACH Msg 1 or RRC connection request that does include field(s) for indicating the form factor or the feature associated with the 2RX-100 MHz feature.

At 658, the base station 654 may check the device form factor or feature(s) indicated at 656 to avoid the misuse of the communication with 2RX and 100 MHz communication bandwidth. For example, the base station 654 may check whether the UE 652 meets the form factor condition or feature condition for 2RX-100 MHz communication based on the form factor information and the feature information the UE 652 provided.

If the base station 654 identifies that the UE 652 meets one or more form factor condition and/or feature condition for 2RX-100 MHz communication, the base station 654 may, at 660, transmit to the UE 652 the acknowledgment acknowledging the 2RX-100 MHz feature. In the example of FIG. 6B, the UE with 2 RX (e.g., UE 652) may use the 2RX-100 MHz feature without waiting for the UE capability inquiry from the base station 604. If the base station determines, at 658, that the condition is not met, the base station may skip sending the acknowledgement.

Through the signaling mechanisms shown in FIG. 6A and FIG. 6B, the network (e.g., base station 604, 654) may accurately identify UEs for the use of the 2RX-100 MHz functionality, mitigating the potential misuse of this feature.

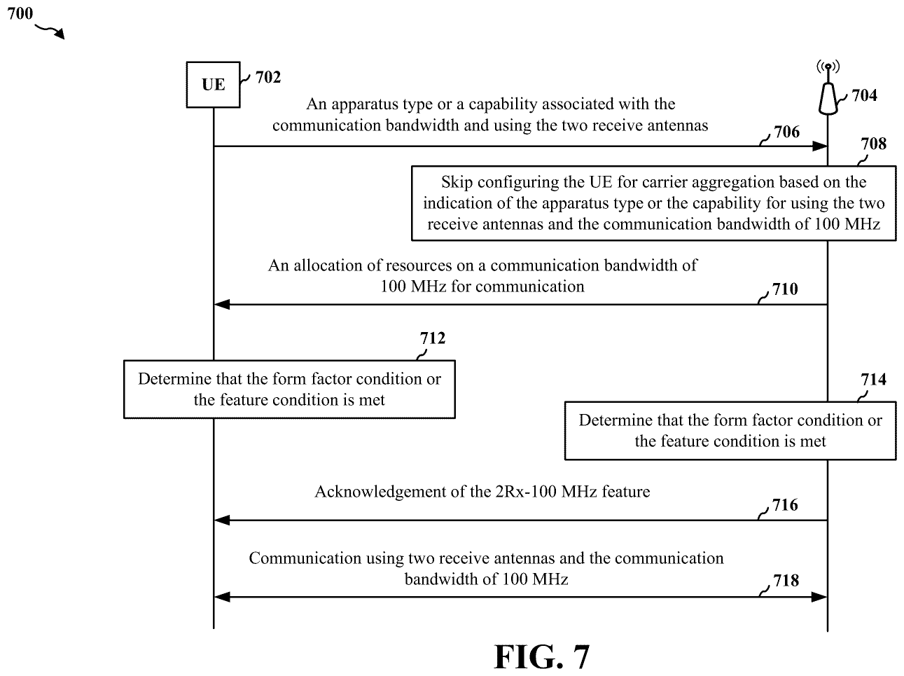

FIG. 7 is a call flow diagram 700 illustrating a method of wireless communication in accordance with various aspects of this present disclosure. Various aspects are described in connection with a UE 702 and a base station 704. The aspects may be performed by the UE 702 or the base station 704 in aggregation and/or by one or more components of a base station 704 (e.g., a CU 110, a DU 130, and/or an RU 140).

As shown in FIG. 7, a UE 702 may transmit to the base station 704 an apparatus type or a capability associated with the communication bandwidth and using the two receive antennas. For example, referring to FIG. 6B, the apparatus type and/or the capability may be one or more form factors of the UE or features of the communication that meet one or more conditions for 2RX-100 MHz wireless communication.

At 708, the base station 704 may skip configuring the UE 702 for carrier aggregation based on the indication of the apparatus type or the capability for using the two receive antennas and the communication bandwidth of 100 MHz.

At 710, the base station 704 may transmit to the UE 702 an allocation of resources on a communication bandwidth of 100 MHz for communication.

In some aspects, at 712, the UE 702 may determine whether the form factor condition or the feature condition for 2RX-100 MHz communication is met.

In some aspects, at 714, the base station 704 may determine whether the form factor condition or the feature condition for 2RX-100 MHz communication is met.

In some aspects, at 716, if the base station 704 determines that the UE 702 meets the form factor condition and the feature condition for 2RX-100 MHz communication, the base station 704 may send to the UE 702 the acknowledgement of the 2RX-100 MHz feature.

At 718, if the UE 702 meets the form factor condition and the feature condition for 2RX-100 MHz communication, the base station 704 may communicate with the UE 702 using the 2RX-100 MHz communication.

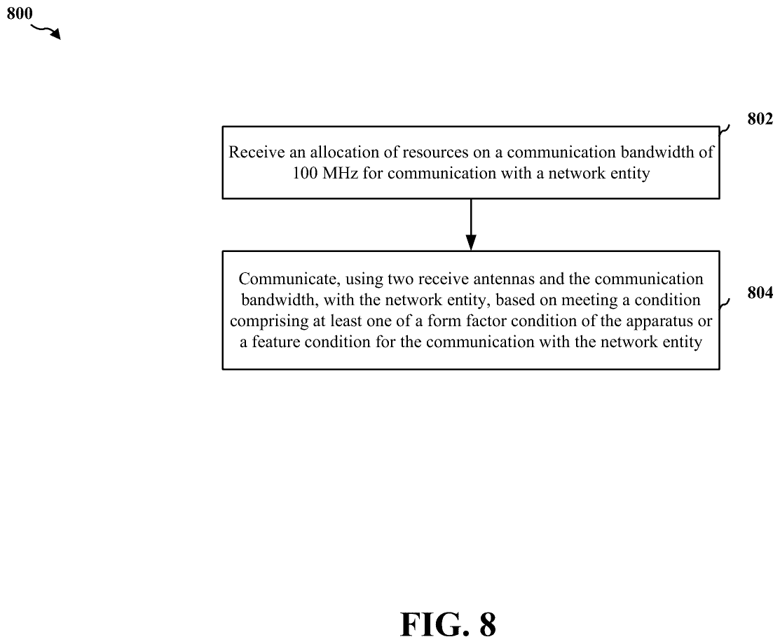

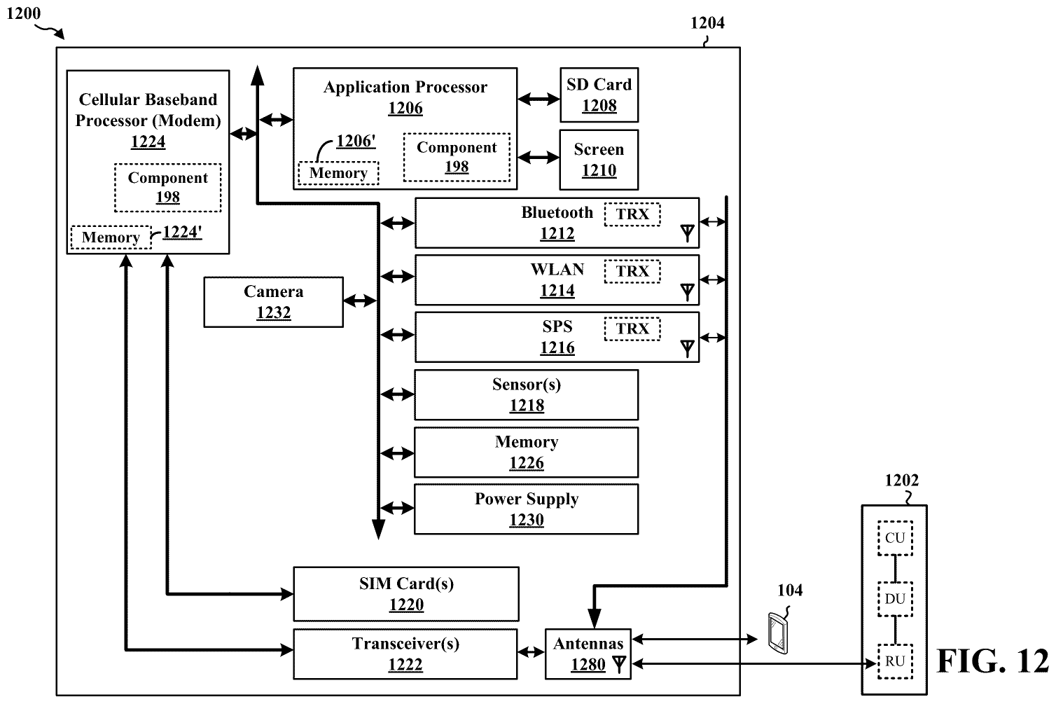

FIG. 8 is a flowchart 800 illustrating methods of wireless communication at a UE in accordance with various aspects of the present disclosure. The method may be performed by a UE. The UE may be the UE 104, 350, 602, 652, 702, or the apparatus 1204 in the hardware implementation of FIG. 12. The method addresses the hardware features in devices that may not enable a 4Rx configuration while still enabling the QOS requirements for traffic such as XR traffic to be met, for example. Additionally, by the use of certain feature conditions, such as conditions for carrier aggregation, rank, and the QoS flows in the communication, the method ensures network integrity and efficiency while using the 2RX-100 MHz devices.

As shown in FIG. 8, at 802, the UE may receive an allocation of resources on a communication bandwidth of 100 MHz for communication with a network entity. The network entity may be a base station, or a component of a base station, in the access network of FIG. 1 or a core network component (e.g., base station 102, 310, 604, 654, 704; or the network entity 1202 in the hardware implementation of FIG. 12). FIGS. 4, 6A, 6B, and 7 illustrate various aspects of the steps in connection with flowchart 800. For example, referring to FIG. 7, the UE 702 may receive, at 710, an allocation of resources on a communication bandwidth of 100 MHz for communication with a network entity (base station 704). In some aspects, 802 may be performed by 2RX communication component 198.

At 804, the UE may communicate, using two receive antennas and the communication bandwidth, with the network entity, based on meeting a condition including at least one of a form factor condition of an apparatus including the UE or a feature condition for the communication with the network entity. For example, referring to FIG. 7, the UE 702 may communicate, at 718, using two receive antennas and the communication bandwidth, with the network entity (base station 704), based on meeting a condition. The condition may include at least one of a form factor condition of an apparatus including the UE or a feature condition for the communication with the network entity. In some aspects, 804 may be performed by 2RX communication component 198.

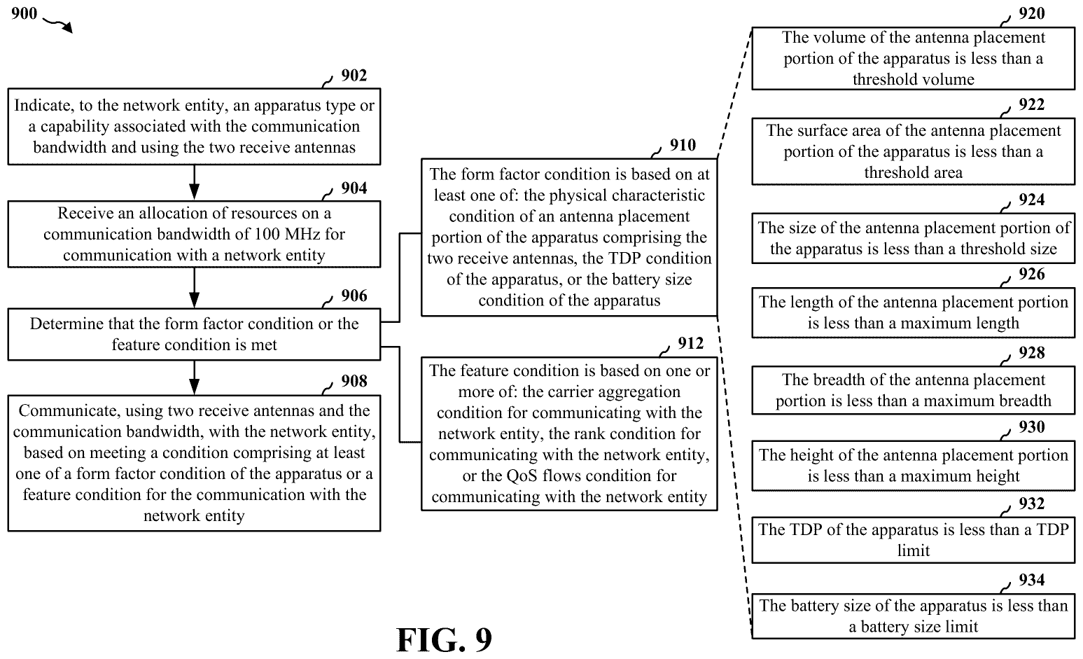

FIG. 9 is a flowchart 900 illustrating methods of wireless communication at a UE in accordance with various aspects of the present disclosure. The method may be performed by a UE. The UE may be the UE 104, 350, 602, 652, 702, or the apparatus 1204 in the hardware implementation of FIG. 12. The method addresses the hardware conditions in devices that may not enable a 4Rx configuration while still meeting the QoS requirements for XR traffic, for example. Additionally, by enforcing certain feature conditions, such as conditions for carrier aggregation, rank, and the QoS flows in the communication, the method ensures network integrity and efficiency while using the 2RX-100 MHz devices.

As shown in FIG. 9, at 904, the UE may receive an allocation of resources on a communication bandwidth of 100 MHz for communication with a network entity. The network entity may be a base station, or a component of a base station, in the access network of FIG. 1 or a core network component (e.g., base station 102, 310, 604, 654, 704; or the network entity 1202 in the hardware implementation of FIG. 12). FIGS. 4, 6A, 6B, and 7 illustrate various aspects of the steps in connection with flowchart 900. For example, referring to FIG. 7, the UE 702 may receive, at 710, an allocation of resources on a communication bandwidth of 100 MHz for communication with a network entity (base station 704). In some aspects, 904 may be performed by 2RX communication component 198.

At 908, the UE may communicate, using two receive antennas and the communication bandwidth, with the network entity, based on meeting a condition including at least one of a form factor condition of the apparatus or a feature condition for the communication with the network entity. For example, referring to FIG. 7, the UE 702 may communicate, at 718, using two receive antennas and the communication bandwidth, with the network entity (base station 704), based on meeting a condition. The condition may include at least one of a form factor condition of an apparatus including the UE or a feature condition for the communication with the network entity. In some aspects, 908 may be performed by 2RX communication component 198.

In some aspects, at 902, the UE may indicate, to the network entity, an apparatus type or a capability associated with the communication bandwidth and using the two receive antennas. For example, referring to FIG. 6A, the UE 602 may indicate, at 608, to the network entity (base station 604), an apparatus type or a capability associated with the communication bandwidth and using the two receive antennas (e.g., the UE capability information including the form factor and features that needs the 2RX-100 MHz feature). Referring to FIG. 7, the UE 702 may indicate, at 706, to the network entity (base station 704), an apparatus type or a capability associated with the communication bandwidth and using the two receive antennas. In some aspects, 902 may be performed by 2RX communication component 198.

In some aspects, at 906, the UE may determine that the form factor condition or the feature condition is met. For example, referring to FIG. 7, the UE 702 may determine, at 712, that the form factor condition or the feature condition is met. In some aspects, 906 may be performed by 2RX communication component 198.

In some aspects, the condition may include the form factor condition of the apparatus. At 910, the form factor condition may be based on at least one of: the physical characteristic condition of an antenna placement portion of the apparatus including the two receive antennas, the TDP condition of the apparatus, or the battery size condition of the apparatus. For example, referring to FIG. 7, when the UE determines the form factor condition (at 712), the form factor condition may be based on at least one of: the physical characteristic condition of an antenna placement portion of the apparatus including the two receive antennas, the TDP condition of the apparatus, or the battery size condition of the apparatus.

In some aspects, the physical characteristic condition of the antenna placement portion may include: the volume of the antenna placement portion of the apparatus is less than a threshold volume (at 920). The threshold volume is based on a frequency range for the communication with the network entity. For example, referring to FIG. 4, the physical characteristic condition of the antenna placement portion may include: the volume of the antenna placement portion (410 and 420) of the apparatus is less than a threshold volume. The threshold volume is based on a frequency range for the communication with the network entity.

In some aspects, the physical characteristic condition of the antenna placement portion may include: the surface area of the antenna placement portion of the apparatus is less than a threshold area (at 922). The threshold area is based on a frequency range for the communication with the network entity. For example, referring to FIG. 4, the physical characteristic condition of the antenna placement portion may include: the surface area of the antenna placement portion of the apparatus (e.g., the surface area of antenna placement portion 410, which is the multiplication of length 412 and breadth 414) is less than a threshold area. The threshold area is based on a frequency range for the communication with the network entity.

In some aspects, the physical characteristic condition of the antenna placement portion may include: the size of the antenna placement portion of the apparatus is less than a threshold size (at 924). The size of the antenna placement portion is the sum of the length, the breadth, and the height of the antenna placement portion, and where the threshold size is based on a frequency range for the communication with the network entity. For example, referring to FIG. 4, the physical characteristic condition of the antenna placement portion may include: the size of the antenna placement portion of the apparatus (e.g., antenna placement portion 410 and 420) is less than a threshold size.

In some aspects, the physical characteristic condition of the antenna placement portion may include one or more of: the length of the antenna placement portion is less than the maximum length (at 926), the breadth of the antenna placement portion is less than the maximum breadth (at 928), or the height of the antenna placement portion being is than the maximum height (at 930). For example, referring to FIG. 4, the physical characteristic condition of the antenna placement portion may include one or more of: the length of the antenna placement portion (e.g., length 412 of the antenna placement portion 410) is less than the maximum length, the breadth of the antenna placement portion (e.g., breadth 414 of the antenna placement portion 410) is less than the maximum breadth, or the height of the antenna placement portion is less than the maximum height.

In some aspects, the TDP condition may include: the TDP of the apparatus is less than a TDP limit (at 932). For example, referring to FIG. 4, the TDP condition may include: the TDP of the apparatus (e.g., device 450) is less than a TDP limit.

In some aspects, the battery size condition may include: the battery size of the apparatus is less than a battery size limit (at 934). For example, referring to FIG. 4, the battery size condition may include: the battery size of the apparatus (e.g., device 450) is less than a battery size limit.

In some aspects, the condition may include the feature condition, and, at 912, the feature condition may be based on one or more of: the carrier aggregation condition for communicating with the network entity, the rank condition for communicating with the network entity, or the QoS flow condition for communicating with the network entity. For example, referring to FIG. 7, when the UE determines the feature condition at 712, the feature condition may be based on one or more of: the carrier aggregation condition for communicating with the network entity (base station 704), the rank condition for communicating with the network entity (base station 704), or the QoS flow condition for communicating with the network entity (base station 704).

In some aspects, the carrier aggregation condition may include a prohibition of carrier aggregation for communicating with the network entity. For example, referring to FIG. 7, the carrier aggregation condition may include a prohibition of carrier aggregation for communicating with the network entity (base station 704).

In some aspects, the rank condition may include a rank for communicating with the network entity not being more than the maximum rank. In some examples, the maximum rank may be 2. For example, referring to FIG. 7, the rank condition may include the rank for communicating with the network entity (base station 704) not being more than the maximum rank, and the maximum rank may be 2.

In some aspects, the QoS flow condition may include the number of the QoS flows is less than the maximum QoS number, and the maximum QoS number may be 32. For example, referring to FIG. 7, the QoS flow condition may include the number of the QoS flows for communicating with the base station 704 is less than the maximum QoS number, and the maximum QoS number may be 32.

In some aspects, the communication may include XR traffic. For example, referring to FIG. 7, the communication (at 718) between the UE 702 and the base station 704 may include XR traffic.

In some aspects, the two receive antennas are coupled to the at least one processor. For example, referring to FIG. 4, the two receive antennas of the device 450 may be coupled to the at least one processor of the device 450.

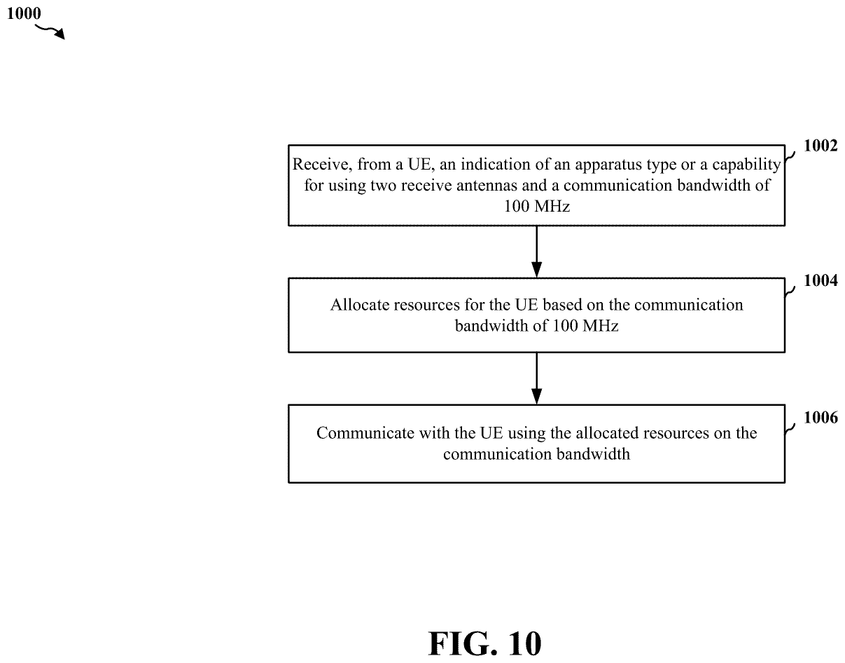

FIG. 10 is a flowchart 1000 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 604, 654, 704; or the network entity 1202 in the hardware implementation of FIG. 12). The method addresses the hardware conditions in devices that may not enable using a 4Rx configuration while still meeting the QoS requirements for XR traffic, for example. Additionally, by enforcing certain feature conditions, such as conditions for carrier aggregation, rank, and the QoS flows in the communication, the method ensures network integrity and efficiency while using the 2RX-100 MHz devices.

As shown in FIG. 10, at 1002, the network entity may receive, from a UE, an indication of an apparatus type or a capability for using two receive antennas and a communication bandwidth of 100 MHz. The UE may be the UE 104, 350, 602, 652, 702, or the apparatus 1204 in the hardware implementation of FIG. 12. FIGS. 4, 6A, 6B, and 7 illustrate various aspects of the steps in connection with flowchart 1000. For example, referring to FIG. 6A, the network entity (base station 604) may receive, at 608, from the UE 602, an apparatus type or a capability associated with the communication bandwidth and using the two receive antennas (e.g., the UE capability information including the form factor and features that needs 2RX-100 MHz features). Referring to FIG. 7, the network entity (base station 704) may receive, at 706, from a UE 702, an indication of an apparatus type or a capability for using two receive antennas and a communication bandwidth of 100 MHz. In some aspects, 1002 may be performed by 2RX communication component 199.

At 1004, the network entity may allocate resources for the UE based on the communication bandwidth of 100 MHz. For example, referring to FIG. 7, the network entity (base station 704) may allocate, at 710, resources for the UE based on the communication bandwidth of 100 MHz. In some aspects, 1004 may be performed by 2RX communication component 199.

At 1006, the network entity may communicate with the UE using the allocated resources on the communication bandwidth. For example, referring to FIG. 7, the network entity (base station 704) may communicate, at 718, with the UE 702 using the allocated resources on the communication bandwidth. In some aspects, 1006 may be performed by 2RX communication component 199.

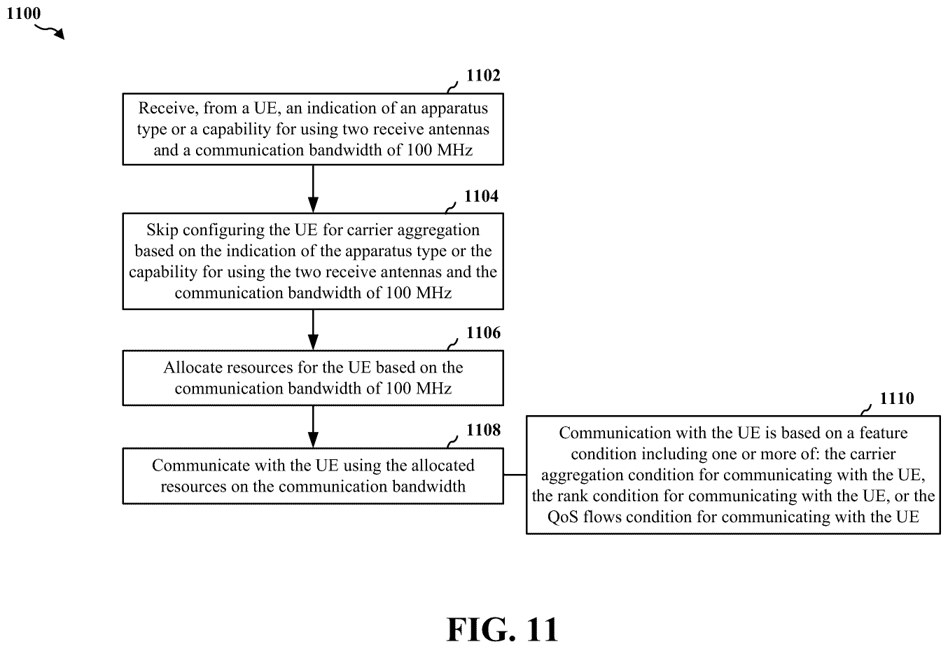

FIG. 11 is a flowchart 1100 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 604, 654, 704; or the network entity 1202 in the hardware implementation of FIG. 12). The method addresses the hardware conditions in devices that may not enable using a 4Rx configuration while still meeting the QoS requirements for XR traffic, for example. Additionally, by enforcing certain feature conditions, such as conditions for carrier aggregation, rank, and the QoS flows in the communication, the method ensures network integrity and efficiency while using the 2RX-100 MHz devices.

As shown in FIG. 11, at 1102, the network entity may receive, from a UE, an indication of an apparatus type or a capability for using two receive antennas and a communication bandwidth of 100 MHz. The UE may be the UE 104, 350, 602, 652, 702, or the apparatus 1204 in the hardware implementation of FIG. 12. FIGS. 4, 6A, 6B, and 7 illustrate various aspects of the steps in connection with flowchart 1100. For example, referring to FIG. 6A, the network entity (base station 604) may receive, at 608, from the UE 602, an apparatus type or a capability associated with the communication bandwidth and using the two receive antennas (e.g., the UE capability information including the form factor and features that needs 2RX-100 MHz features). Referring to FIG. 7, the network entity (base station 704) may receive, at 706, from a UE 702, an indication of an apparatus type or a capability for using two receive antennas and a communication bandwidth of 100 MHz. In some aspects, 1102 may be performed by 2RX communication component 199.

At 1106, the network entity may allocate resources for the UE based on the communication bandwidth of 100 MHz. For example, referring to FIG. 7, the network entity (base station 704) may allocate, at 710, resources for the UE based on the communication bandwidth of 100 MHz. In some aspects, 1106 may be performed by 2RX communication component 199.

At 1108, the network entity may communicate with the UE using the allocated resources on the communication bandwidth. For example, referring to FIG. 7, the network entity (base station 704) may communicate, at 718, with the UE 702 using the allocated resources on the communication bandwidth. In some aspects, 1108 may be performed by 2RX communication component 199.

In some aspects, at 1110, the communication with the UE may be based on a feature condition including one or more of: the carrier aggregation condition for communicating with the UE, the rank condition for communicating with the UE, or the QoS flow condition for communicating with the UE. For example, referring to FIG. 7, the communication (at 718) with the UE 702 may be based on a feature condition including one or more of: the carrier aggregation condition for communicating with the UE 702, the rank condition for communicating with the UE 702, or the QoS flow condition for communicating with the UE 702.

In some aspects, at 1104, the network entity may skip configuring the UE for carrier aggregation based on the indication of the apparatus type or the capability for using the two receive antennas and the communication bandwidth of 100 MHz. For example, referring to FIG. 7, the network entity (base station 704) may skip, at 708, configuring the UE 702 for carrier aggregation based on the indication of the apparatus type or the capability for using the two receive antennas and the communication bandwidth of 100 MHz. In some aspects, 1104 may be performed by 2RX communication component 199.

In some aspects, the rank condition may include a rank for the communication with the UE being not more than the maximum rank. In some examples, the maximum rank may be 2. For example, referring to FIG. 7, the rank condition (which may be included in the feature condition in 714) may include the rank for the communication 718 with the UE 702 being not more than the maximum rank. In some examples, the maximum rank may be 2.

In some aspects, the QoS flow condition may include the number of the QoS flows is less than the maximum QoS number. In some examples, the maximum QoS number may be 32. For example, referring to FIG. 7, the QoS flow condition (which may be included in the feature condition in 714) may include the number of the QoS flows for the communication 718 with the UE 702 is less than the maximum QoS number. In some examples, the maximum QoS number may be 32.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor (or processing circuitry) 1224 (also referred to as a modem) coupled to one or more transceivers 1222 (e.g., cellular RF transceiver). The cellular baseband processor(s) (or processing circuitry) 1224 may include at least one on-chip memory (or memory circuitry) 1224′. In some aspects, the apparatus 1204 may further include one or more subscriber identity modules (SIM) cards 1220 and at least one application processor (or processing circuitry) 1206 coupled to a secure digital (SD) card 1208 and a screen 1210. The application processor(s) (or processing circuitry) 1206 may include on-chip memory (or memory circuitry) 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) (or processing circuitry) 1224 communicates through the transceiver(s) 1222 via one or more antennas 1280 with the UE 104 and/or with an RU associated with a network entity 1202. The cellular baseband processor(s) (or processing circuitry) 1224 and the application processor(s) (or processing circuitry) 1206 may each include a computer-readable medium/memory (or memory circuitry) 1224′, 1206′, respectively. The additional memory modules 1226 may also be considered a computer-readable medium/memory (or memory circuitry). Each computer-readable medium/memory (or memory circuitry) 1224′, 1206′, 1226 may be non-transitory. The cellular baseband processor(s) (or processing circuitry) 1224 and the application processor(s) (or processing circuitry) 1206 are each responsible for general processing, including the execution of software stored on the computer-readable medium/memory (or memory circuitry). The software, when executed by the cellular baseband processor(s) (or processing circuitry) 1224/application processor(s) (or processing circuitry) 1206, causes the cellular baseband processor(s) (or processing circuitry) 1224/application processor(s) (or processing circuitry) 1206 to perform the various functions described supra. The cellular baseband processor(s) (or processing circuitry) 1224 and the application processor(s) (or processing circuitry) 1206 are configured to perform the various functions described supra based at least in part of the information stored in the memory (or memory circuitry). That is, the cellular baseband processor(s) (or processing circuitry) 1224 and the application processor(s) (or processing circuitry) 1206 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1224/application processor(s) (or processing circuitry) 1206 when executing software. The cellular baseband processor(s) (or processing circuitry) 1224/application processor(s) (or processing circuitry) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) (or processing circuitry) 1224 and/or the application processor(s) (or processing circuitry) 1206, and in another configuration, the apparatus 1204 may be the entire UE (e.g., see UE 350 of FIG. 3) and include the additional modules of the apparatus 1204.

As discussed supra, the component 198 may be configured to receive an allocation of resources on a communication bandwidth of 100 MHz for communication with a network entity; and communicate, using two receive antennas and the communication bandwidth, with the network entity, based on meeting a condition including at least one of a form factor condition of the apparatus or a feature condition for the communication with the network entity. The component 198 may be further configured to perform any of the aspects described in connection with the flowcharts in FIG. 8 and FIG. 9, and/or performed by the UE 702 in FIG. 7. The component 198 may be within the cellular baseband processor(s) (or processing circuitry) 1224, the application processor(s) (or processing circuitry) 1206, or both the cellular baseband processor(s) (or processing circuitry) 1224 and the application processor(s) (or processing circuitry) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) (or processing circuitry) 1224 and/or the application processor(s) (or processing circuitry) 1206, includes means for receiving an allocation of resources on a communication bandwidth of 100 MHz for communication with a network entity, and means for communicating, using two receive antennas and the communication bandwidth, with the network entity, based on meeting a condition including at least one of a form factor condition of the apparatus or a feature condition for the communication with the network entity. The apparatus 1204 may further include means for performing any of the aspects described in connection with the flowcharts in FIG. 8 and FIG. 9, and/or aspects performed by the UE 702 in FIG. 7. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

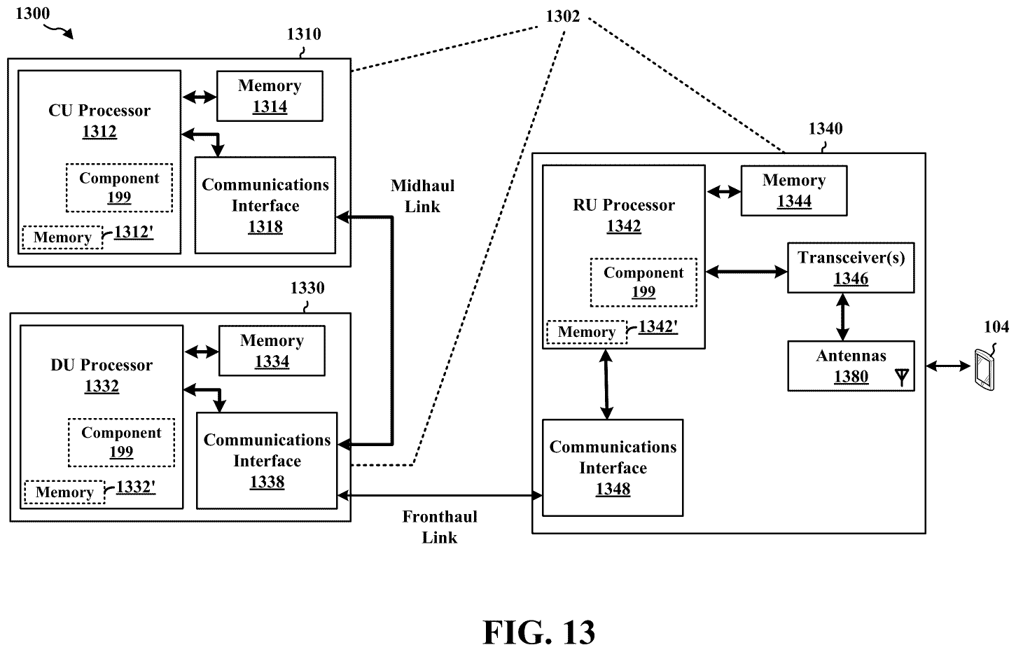

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor (or processing circuitry) 1312. The CU processor(s) (or processing circuitry) 1312 may include on-chip memory (or memory circuitry) 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor (or processing circuitry) 1332. The DU processor(s) (or processing circuitry) 1332 may include on-chip memory (or memory circuitry) 1332′. In some aspects, the DU 1330 may further include additional memory modules 1334 and a communications interface 1338. The DU 1330 communicates with the RU 1340 through a fronthaul link. The RU 1340 may include at least one RU processor (or processing circuitry) 1342. The RU processor(s) (or processing circuitry) 1342 may include on-chip memory (or memory circuitry) 1342′. In some aspects, the RU 1340 may further include additional memory modules 1344, one or more transceivers 1346, antennas 1380, and a communications interface 1348. The RU 1340 communicates with the UE 104. The on-chip memory (or memory circuitry) 1312′, 1332′, 1342′ and the additional memory modules 1314, 1334, 1344 may each be considered a computer-readable medium/memory (or memory circuitry). Each computer-readable medium/memory (or memory circuitry) may be non-transitory. Each of the processors (or processing circuitry) 1312, 1332, 1342 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to receive, from a UE, an indication of an apparatus type or a capability for using two receive antennas and a communication bandwidth of 100 MHz; allocate resources for the UE based on the communication bandwidth of 100 MHz; and communicate with the UE using the allocated resources on the communication bandwidth. The component 199 may be further configured to perform any of the aspects described in connection with the flowcharts in FIG. 10 and FIG. 11, and/or performed by the base station 704 in FIG. 7. The component 199 may be within one or more processors (or processing circuitry) of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 includes means for receiving, from a UE, an indication of an apparatus type or a capability for using two receive antennas and a communication bandwidth of 100 MHz, means for allocating resources for the UE based on the communication bandwidth of 100 MHz, and means for communicating with the UE using the allocated resources on the communication bandwidth. The network entity 1302 may further include means for performing any of the aspects described in connection with the flowcharts in FIG. 10 and FIG. 11, and/or aspects performed by the base station 704 in FIG. 7. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving an allocation of resources on a communication bandwidth of 100 MHz for communication with a network entity; and communicating, using two receive antennas and the communication bandwidth, with the network entity, based on meeting a condition including at least one of a form factor condition of the apparatus or a feature condition for the communication with the network entity. The method addresses the hardware conditions in devices that may not enable using a 4Rx configuration while still meeting the QoS requirements for XR traffic, for example. Additionally, by enforcing certain feature conditions, such as conditions for carrier aggregation, rank, and the QoS flows in the communication, the method ensures network integrity and efficiency while using the 2RX-100 MHz devices.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method may include receiving an allocation of resources on a communication bandwidth of 100 MHz for communication with a network entity; and communicating, using two receive antennas and the communication bandwidth, with the network entity, based on meeting a condition comprising at least one of a form factor condition of an apparatus comprising the UE or a feature condition for the communication with the network entity.

Aspect 2 is the method of aspect 1, where the method may further include indicating, to the network entity, an apparatus type or a capability associated with the communication bandwidth and using the two receive antennas.

Aspect 3 is the method of any of aspects 1 to 2, where the method may further include determining that the form factor condition or the feature condition is met before exchange of the communication using the two receive antennas and the communication bandwidth.

Aspect 4 is the method of aspect 1, where the condition may include the form factor condition of the apparatus. The form factor condition may be based on at least one of: a physical characteristic condition of an antenna placement portion of the apparatus including the two receive antennas, the TDP condition of the apparatus, or the battery size condition of the apparatus.

Aspect 5 is the method of aspect 4, where the physical characteristic condition of the antenna placement portion may include the volume of the antenna placement portion of the apparatus is less than a threshold volume. The threshold volume may be based on a frequency range for the communication with the network entity.

Aspect 6 is the method of aspect 4, where the physical characteristic condition of the antenna placement portion may include the surface area of the antenna placement portion of the apparatus is less than a threshold area. The threshold area may be based on a frequency range for the communication with the network entity.

Aspect 7 is the method of aspect 4, where the physical characteristic condition of the antenna placement portion may include the size of the antenna placement portion of the apparatus is less than a threshold size. The size of the antenna placement portion may be the sum of the length, the breadth, and the height of the antenna placement portion, and the threshold size may be based on a frequency range for the communication with the network entity.

Aspect 8 is the method of aspect 4, where the physical characteristic condition of the antenna placement portion may include one or more of: the length of the antenna placement portion is less than the maximum length, the breadth of the antenna placement portion is less than the maximum breadth, or the height of the antenna placement portion is less than the maximum height.

Aspect 9 is the method of aspect 4, where the TDP condition may include: the TDP of the apparatus is less than a TDP limit.

Aspect 10 is the method of aspect 4, where the battery size condition may include: the battery size of the apparatus is less than a battery size limit.

Aspect 11 is the method of aspect 1, where the condition may include the feature condition that is based on one or more of: the carrier aggregation condition for communicating with the network entity, the rank condition for communicating with the network entity, or the QoS flow condition for communicating with the network entity.

Aspect 12 is the method of aspect 11, where the carrier aggregation condition may include the prohibition of carrier aggregation for communicating with the network entity.

Aspect 13 is the method of aspect 11, where the rank condition may include the rank for communicating with the network entity not being more than a maximum rank.

Aspect 14 is the method of aspect 13, where the maximum rank may be 2.

Aspect 15 is the method of aspect 11, where the QoS flow condition may include the number of the QoS flows is less than a maximum QoS number.

Aspect 16 is the method of aspect 15, where the maximum QoS number may be 32.

Aspect 17 is the method of any of aspects 1 to 16, where the communication may include XR traffic.

Aspect 18 is the method of any of aspects 1 to 17, where the apparatus may include at least one processor, and the two receive antennas are coupled to the at least one processor.

Aspect 19 is an apparatus for wireless communication at a UE, including: at least one memory; and at least one processor coupled to the at least one memory and, based at least in part on information stored in the at least one memory, the at least one processor, individually or in any combination, is configured to perform the method of any of aspects 1-18.

Aspect 20 is the apparatus of aspect 19, further including at least one of a transceiver or an antenna coupled to the at least one processor and configured to communicate with the network entity.

Aspect 21 is an apparatus for wireless communication including means for implementing the method of any of aspects 1-18.

Aspect 22 is a computer-readable medium (e.g., a non-transitory computer-readable medium) storing computer executable code, where the code when executed by at least one processor causes the at least one processor to, individually or in any combination, implement the method of any of aspects 1-18.

Aspect 23 is a method of wireless communication at a network entity. The method may include receiving, from a UE, an indication of an apparatus type or a capability for using two receive antennas and a communication bandwidth of 100 MHz; allocating resources for the UE based on the communication bandwidth of 100 MHz; and communicating with the UE using the allocated resources on the communication bandwidth.

Aspect 24 is the method of aspect 23, where communication with the UE may be based on a feature condition including one or more of: the carrier aggregation condition for communicating with the UE, the rank condition for communicating with the UE, or the QoS flow condition for communicating with the UE.

Aspect 25 is the method of any of aspects 23 to 24, where the method may further include skipping configuring the UE for carrier aggregation based on the indication of the apparatus type or the capability for using the two receive antennas and the communication bandwidth of 100 MHz.

Aspect 26 is the method of aspect 24, where the rank condition may include the rank for the communication with the UE being not more than a maximum rank.

Aspect 27 is the method of aspect 26, where the maximum rank may be 2.

Aspect 28 is the method of aspect 24, where the QoS flow condition may include the number of the QoS flows is less than a maximum QoS number.

Aspect 29 is the method of aspect 28, where the maximum QoS number may be 32.

Aspect 30 is an apparatus for wireless communication at a network entity, including: at least one memory; and at least one processor coupled to the at least one memory and, based at least in part on information stored in the at least one memory, the at least one processor, individually or in any combination, is configured to perform the method of any of aspects 23-29.

Aspect 31 is the apparatus of aspect 30, further including at least one of a transceiver or an antenna coupled to the at least one processor and configured to communicate with the UE using the allocated resources on the communication bandwidth.

Aspect 32 is an apparatus for wireless communication including means for implementing the method of any of aspects 23-29.

Aspect 33 is a computer-readable medium (e.g., a non-transitory computer-readable medium) storing computer executable code, where the code when executed by at least one processor causes the at least one processor to, individually or in any combination, implement the method of any of aspects 23-29.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
receive an allocation of resources on a communication bandwidth of 100 MHz for communication with a network entity; and
communicate, using two receive antennas and the communication bandwidth, with the network entity, based on meeting a condition comprising at least one of a form factor condition of the apparatus or a feature condition for the communication with the network entity.

2. The apparatus of claim 1, further comprising a transceiver coupled to the at least one processor, wherein, to receive the allocation of the resources on the communication bandwidth of 100 MHz, the at least one processor, individually or in any combination, is configured to cause the apparatus to receive the allocation of the resources on the communication bandwidth of 100 MHz via the transceiver, and wherein the at least one processor, individually or in any combination, is further configured to cause the UE to:
indicate, to the network entity, an apparatus type or a capability associated with the communication bandwidth and using the two receive antennas.

3. The apparatus of claim 1, wherein the at least one processor, individually or in any combination, is further configured to cause the UE to:
determine that the form factor condition or the feature condition is met before exchange of the communication using the two receive antennas and the communication bandwidth.

4. The apparatus of claim 1, wherein the condition includes the form factor condition of the apparatus, the form factor condition being based on at least one of:
a physical characteristic condition of an antenna placement portion of the apparatus comprising the two receive antennas,
a thermal dissipation and power (TDP) condition of the apparatus, or
a battery size condition of the apparatus.

5. The apparatus of claim 4, wherein the physical characteristic condition of the antenna placement portion includes:
a volume of the antenna placement portion of the apparatus being less than a threshold volume, wherein the threshold volume is based on a frequency range for the communication with the network entity.

6. The apparatus of claim 4, wherein the physical characteristic condition of the antenna placement portion includes:
a surface area of the antenna placement portion of the apparatus being less than a threshold area, wherein the threshold area is based on a frequency range for the communication with the network entity.

7. The apparatus of claim 4, wherein the physical characteristic condition of the antenna placement portion includes:
a size of the antenna placement portion of the apparatus being less than a threshold size, wherein the size of the antenna placement portion is a sum of a length, a breadth, and a height of the antenna placement portion, and wherein the threshold size is based on a frequency range for the communication with the network entity.

8. The apparatus of claim 4, wherein the physical characteristic condition of the antenna placement portion includes one or more of:
a length of the antenna placement portion being less than a maximum length,
a breadth of the antenna placement portion being less than a maximum breadth, or
a height of the antenna placement portion being less than a maximum height.

9. The apparatus of claim 4, wherein the TDP condition includes:
a TDP of the apparatus being less than a TDP limit.

10. The apparatus of claim 4, wherein the battery size condition includes:
a battery size of the apparatus being less than a battery size limit.

11. The apparatus of claim 1, wherein the condition includes the feature condition that is based on one or more of:
a carrier aggregation condition for communicating with the network entity,
a rank condition for communicating with the network entity, or
a Quality of Service (QOS) flow condition for communicating with the network entity.

12. The apparatus of claim 11, wherein the carrier aggregation condition includes a prohibition of carrier aggregation for communicating with the network entity.

13. The apparatus of claim 11, wherein the rank condition includes a rank for communicating with the network entity not being more than a maximum rank.

14. The apparatus of claim 13, wherein the maximum rank is 2.

15. The apparatus of claim 11, wherein the QoS flow condition includes a number of QoS flows being less than a maximum QoS number.

16. The apparatus of claim 15, wherein the maximum QoS number is 32.

17. The apparatus of claim 1, wherein the communication comprises extended reality (XR) traffic.

18. The apparatus of claim 1, further comprising the two receive antennas, wherein the two receive antennas are coupled to the at least one processor.

19. A method of wireless communication at a user equipment (UE), comprising:
receiving an allocation of resources on a communication bandwidth of 100 MHz for communication with a network entity; and
communicating, using two receive antennas and the communication bandwidth, with the network entity, based on meeting a condition comprising at least one of a form factor condition of an apparatus comprising the UE or a feature condition for the communication with the network entity.

20. A computer-readable medium storing computer executable code for wireless communication at a user equipment (UE), the code when executed by at least one processor causes the at least one processor, individually or in any combination, to:
receive an allocation of resources on a communication bandwidth of 100 MHz for communication with a network entity; and
communicate, using two receive antennas and the communication bandwidth, with the network entity, based on meeting a condition comprising at least one of a form factor condition of an apparatus comprising the UE or a feature condition for the communication with the network entity.
